(19) United States
(12) Patent Application Publication
(10) Pub. No.: US 2025/0205558 A1
(43) Pub. Date: Jun. 26, 2025

(54) GOLF BALL

(71) Applicant: Bridgestone Sports Co., Ltd., Tokyo (JP)

(72) Inventors: Kae IIZUKA, Chichibushi (JP); Yuki MIZUNO, Chichibushi (JP); Hirotaka SHINOHARA, Chichibushi (JP)

(73) Assignee: Bridgestone Sports Co., Ltd., Tokyo (JP)

(21) Appl. No.: 18/977,019

(22) Filed: Dec. 11, 2024

(30) Foreign Application Priority Data
Dec. 21, 2023 (JP) 2023-215479

(51) Int. Cl. A63B 37/00; C09D 133/04; C09D 175/06

(52) U.S. Cl. CPC A63B 37/00221; A63B 37/0012; A63B 37/0031; A63B 37/0064; A63B 37/0065; A63B 37/0074; A63B 37/0087; C09D 133/04; C09D 175/06

(57) ABSTRACT

In a golf ball having a core and a cover with numerous dimples thereon, the cover has a given material hardness, the ball has a specific compressive deformation when compressed under a given load, the outer surface of the cover has a paint coat thereon composed of an inner layer and an outer layer, the inner paint layer being formed of a coating composition containing specific base resins and the outer paint layer being formed of a two-part curable urethane coating composition which contains less than 5 wt % of an inorganic or organic filler based on the solids content of the base resins, and the paint layers have optimized ratios between their thicknesses at the dimple center and at the dimple edges. This golf ball satisfies the properties desired in practice golf balls, such as scratch resistance, peeling resistance and durability to cracking.

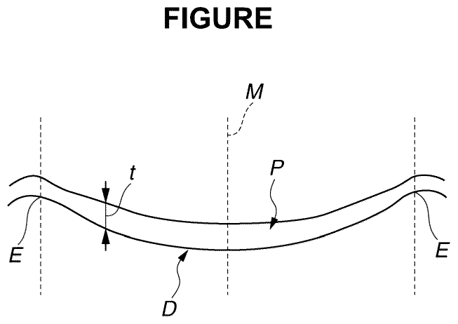

### CROSS-REFERENCE TO RELATED APPLICATIONS

This non-provisional application claims priority under 35 U.S.C. § 119(a) on Patent Application No. 2023-215479 filed in Japan on Dec. 21, 2023, the entire contents of which are hereby incorporated by reference.

### TECHNICAL FIELD

The present invention relates to golf balls, such as practice golf balls, that have a core and a cover and in which the surface of the cover has numerous dimples and two paint layers formed thereon.

### BACKGROUND ART

The performance desired of a golf ball at a golf practice range, given the usage environment, differs from that of a golf ball used on an ordinary golf course. At a golf practice range, because random users hit the golf ball and the ball is repeatedly used over a long period of time, the appearance properties are also regarded as important. At times, users at golf practice ranges even complain more about the appearance of a ball than about its performance.

The qualities desired in the appearance of a practice golf ball include excellent scratch resistance, no peeling of the markings, discoloration resistance and good surface glossiness. In terms of ball performance, the chief desire is durability to cracking on repeated impact because practice golf balls are repeatedly used over a long period of time in a harsh environment.

To satisfy the above demands concerning practice golf balls, there is a desire that the paint layer (paint film) applied to the cover surface be improved. Two-part curable polyurethane coatings prepared by mixing together a polyol and a polyisocyanate just prior to use are employed as the chief coating compositions in conventional golf balls for such reasons as their ability to withstand large deformation and endure impacts and friction. However, when the coating compositions used in prior-art golf balls are applied onto a golf ball, the film thickness at the dimple edges generally becomes thin. Such places where the paint film has a small thickness tend to become areas that have a poor scratch resistance and a low resistance to peeling.

JP-A 2006-51357, JP-A H08-10356, JP-A 2022-99601 and JP-A 2003-52858 disclose art that improves two-part curable polyurethane coating compositions for golf balls.

JP-A 2006-51357 describes a golf ball in which the paint contains silica particles having an average particle size of 200 nm or less, and JP-A H08-10356 describes a golf ball that uses a paint in which fine particles of an acrylic-styrene copolymer resin or other polymer gel are dispersed. However, in the golf balls described in these patent disclosures, the paint layer does not have a sufficiently improved scratch resistance and peel resistance.

JP-A 2022-99601 describes the formation of two paint layers on the cover surface, which paint layers are uniformly formed by using a low-boiling solvent. JP-A 2003-52858 describes the formation of two paint layers in which differing paint layers obtained using an epoxy resin and a urethane resin as the base resins are separately formed, enhancing the durability of markings.

However, it is difficult for the golf balls described in both JP-A 2022-99601 and JP-A 2003-52858 to achieve, in a harsh environment of the sort encountered on a golf practice range, the desired durability to repeated impact and also all the following ball appearance characteristics: scratch resistance, durability to the peeling of markings and surface glossiness.

### SUMMARY OF THE INVENTION

It is therefore an object of the present invention to provide a golf ball which, even in a harsh environment of the sort encountered on a golf practice range, has a ball appearance characterized by good scratch resistance, durability to the peeling of markings and surface glossiness, and which moreover has an excellent durability to cracking under repeated impact.

As a result of intensive investigations, we have discovered that, in a golf ball having a core and a cover of at least one layer encasing the core, by designing the golf ball such that the material hardness of the cover on the Shore D hardness scale is less than 60, the overall ball has a compressive deformation within the range of from 2.7 to 3.3 mm when compressed under a given load, and the outside surface of the cover has formed thereon a paint coat composed of two layers—an inner layer and an outer layer, the inner paint layer being formed of a coating composition that includes as base resins an acrylic resin and a urethane resin and the outer paint layer being formed of a two-part curable urethane coating composition having a polyol component and a polyisocyanate component and containing less than 5 wt % of an inorganic or organic filler based on the solids contents of the base resins therein, the golf ball fully satisfies the desired durability to cracking on repeated impact in a harsh environment of the sort encountered with use on a golf practice range and moreover has ball appearance properties (scratch resistance, durability to peeling of markings, surface glossiness) desired by users of practice golf balls that are all good.

Accordingly, the invention provides a golf ball having a core and a cover of at least one layer which encases the core and has an outer surface on which numerous dimples are formed, wherein the cover has a material hardness on the Shore D hardness scale of less than 60; the outer surface of the cover has a paint coat thereon which is composed of at least two layers—an inner layer and an outer layer, the inner paint layer being formed of a coating composition that includes as base resins an acrylic resin and a urethane resin and the outer paint layer being formed of a two-part curable urethane coating composition that includes a polyol component and a polyisocyanate component and contains less than 5 wt % of an inorganic or organic filler based on the solids contents of the base resins; in a dimple cross-section, defining the ratio between the thickness of a paint layer (film thickness) formed at a center portion (bottom) of the dimple and the thickness of the paint layer formed at edge portions of the dimple as the edge ratio:

$$( film thickness at dimple edge ) / ( film thickness at dimple center ) \times 100 ,$$

and letting E1 be the edge ratio of the inner paint layer, E2 be the edge ratio of the outer paint layer and ET be the edge ratio of the overall paint coat, the golf ball satisfies the conditions −10≤E2-E1≤10 and ET-E2≥0; and the golf ball, when compressed under a final load of 1,275 N (130 kgf) from an initial load state of 98 N (10 kgf), has a compressive deformation of from 2.7 to 3.3 mm.

In a preferred embodiment of the golf ball of the invention, the coating composition for the inner paint layer has an acrylic resin content that is at least 50 wt % of the overall base resin.

In another preferred embodiment of the inventive golf ball, the inorganic or organic filler in the coating composition for the outer paint layer has an average particle size based on the BET method of from 0.1 to 1.0 μm.

In yet another preferred embodiment, the two-part curable urethane coating composition for the outer paint layer includes a polyol component which is composed primarily of a hydroxyl group-containing polyester polyol having an alicyclic structure on the molecule and a non-yellowing polyisocyanate.

In still another preferred embodiment, the two-part curable urethane coating composition for the outer paint layer includes a polyol component which is composed primarily of an acrylic polyol and an isocyanate component which is composed primarily of an elastic modified polyisocyanate.

In a further preferred embodiment, the two-part curable urethane coating composition has a viscosity following mixture of the two parts which is at least 0.025 Pa·s, as measured by the test method of JIS-K 5600-2-2 (1999).

In a yet further preferred embodiment, the inner paint layer has a thickness of from 5 to 15 μm.

In a still further preferred embodiment, the outer paint layer has a thickness of from 17 to 23 μm.

In yet another preferred embodiment, the core has a diameter of 40 mm or less and, when compressed under a final load of 1,275 N (130 kgf) from an initial load state of 98 N (10 kgf), has a compressive deformation of from 3.0 to 4.0 mm.

In still another preferred embodiment, at least one layer of the cover is formed of a resin composition containing component (a) below and/or component (b) below:
(a) an ionic ethylene-methacrylic acid-unsaturated carboxylic acid copolymer having an unsaturated carboxylic acid content of 5 wt % or more,
(b) an ionic ethylene-methacrylic acid-unsaturated carboxylic acid ester copolymer having an unsaturated carboxylic acid content of 5 wt % or more.

### Advantageous Effects of the Invention

The golf ball of the invention fully satisfies the performance requirements of practice golf balls, such as scratch resistance, durability to the peeling of markings and durability to cracking on repeated impact. The inventive golf ball is thus useful particularly as a practice golf ball, or “range ball.”

### BRIEF DESCRIPTION OF THE DRAWINGS

The Figure is a schematic diagram illustrating, in a cross-section of a dimple, the thickness of a paint layer formed at center and edge portions of the dimple.

### DETAILED DESCRIPTION OF THE INVENTION

The objects, features and advantages of the invention will become more apparent from the following detailed description taken in conjunction with the appended diagram.

The golf ball of the invention has a core and a cover of at least one layer encasing the core. Numerous dimples are formed on the outer surface of the cover.

The core may be formed of a known rubber material as the base material. Known base rubbers such as natural rubbers or synthetic rubbers may be used as the base rubber. More specifically, it is recommended that polybutadiene, especially cis-1,4-polybutadiene having a cis structure content of at least 40%, be chiefly used. If desired, natural rubber, polyisoprene rubber, styrene-butadiene rubber or the like may be used together with the above polybutadiene in the base rubber. The polybutadiene may be synthesized with a titanium-based, cobalt-based, nickel-based, neodymium-based or other Ziegler-type catalyst or with a metal catalyst such as cobalt or nickel.

Co-crosslinking agents such as unsaturated carboxylic acids and metal salts thereof, inorganic fillers such as zinc oxide, barium sulfate and calcium carbonate, and organic peroxides such as dicumyl peroxide and 1,1-bis(t-butylperoxy)cyclohexane may be included in the base rubber. If necessary, commercial antioxidants and the like may be suitably added.

The core is a hot-molded product obtained by heating and curing the above rubber material. The core may be a single-layer core or a multilayer core. The hot-molded product may be used as all or part of a single-layer or multilayer core. For example, production may be carried out by kneading the composition using a mixer such as a Banbury mixer or a roll mill, compression molding or injection molding the kneaded composition using a core mold, and curing the molded body by suitably heating it at a temperature sufficient for the organic peroxide and the co-crosslinking agent to act, such as between 100° C. and 200° C., for a period of between 10 and 40 minutes.

The diameter of the core, although not particularly limited, is preferably 40 mm or less. At a core diameter greater than 40 mm, the durability to cracking may worsen and the ball may be incapable of withstanding long-term use.

The core has a compression hardness (deformation) when compressed under a final load of 1,275 N (130 kgf) from an initial load state of 98 N (10 kgf) which, although not particularly limited, is preferably at least 3.0 mm, and more preferably at least 3.2 mm, and is preferably not more than 4.0 mm, and more preferably not more than 3.8 mm. When this compression hardness falls outside of the above range, the feel is too soft or too hard, and so is of a hardness that pleases only certain users, making it unsuitable particularly as a practice golf ball. In particular, when the compression hardness is too high, this leads to early cracking of the ball, resulting in a loss of properties as a practice golf ball.

The cover material is not particularly limited. Various resin material employed in golf balls may be used. In particular, in the inventive golf ball, it is preferable for the cover material to be formed of a resin composition containing component (a) and/or component (b) below:
(a) an ionic ethylene-methacrylic acid-unsaturated carboxylic acid copolymer having an unsaturated carboxylic acid content of 5 wt % or more,
(b) an ionic ethylene-methacrylic acid-unsaturated carboxylic acid ester copolymer having an unsaturated carboxylic acid content of 5 wt % or more.

It is suitable to use either acrylic acid or methacrylic acid as the unsaturated carboxylic acid of component (a). A lower alkyl ester is preferred as the unsaturated carboxylic acid ester of component (b); butyl acrylate (n-butyl acrylate, butyl acrylate) is especially preferred. The upper limit of the unsaturated carboxylic acid contents (acid contents) in components (a) and (b) is preferably 25 wt % or less.

Components (a) and (b) are both ionic resins. In these components, the type of metal salt that neutralizes the acid groups should be an inorganic metallic species having a valence of from 1 to 3. Specific examples include zinc, sodium, magnesium, potassium and calcium; the use of zinc or sodium is especially preferred.

Specific examples of components (a) and (b) include the Iotek® series from ExxonMobil Corporation, the Himilan™ series from Dow-Mitsui Polychemicals Co., Ltd., and the Surlyn™ series ionomer resins from The Dow Chemical Company.

Aside from the above resin materials, other thermoplastic elastomers, fatty acids or derivatives thereof, basic inorganic metal compounds, fillers and various additives may be added to the cover.

To obtain the above cover, use can be made of, for example, a method in which, depending on the type of ball being produced, a prefabricated single-layer or multilayer core of two or more layers is placed in a mold and the above mixture is mixed and melted under heating and then injection-molded over the core, thereby encasing the core with the desired cover. Another method that may be used to form the cover involves molding the cover material of the invention into a pair of hemispherical half-cups, enclosing the core with these half-cups, and then molding under applied pressure at between 120° C. and 170° C. for a period of from 1 to 5 minutes.

The thickness of the cover may be set to from 0.3 to 3.0 mm, and is preferably set in the range of 0.5 to 2.0 mm. The cover has a material hardness on the Shore D hardness scale which, although not particularly limited, is set to preferably 40 or more, and more preferably 50 or more. The upper limit is preferably 60 or less.

Numerous dimples are formed on the surface of the outermost layer of the cover. The number of dimples provided on the cover surface, although not particularly limited, is preferably at least 250, and more preferably at least 300, but preferably not more than 420, and more preferably not more than 400 dimples. The dimple shapes used may be of one type or may be a combination of two or more types selected from among, for example, circular shapes, various polygonal shapes, dewdrop shapes and oval shapes. When circular dimples are used, the dimple diameter may be set to at least about 2.5 mm and up to about 6.5 mm, and the dimple depth may be set to at least 0.08 mm and up to 0.30 mm.

A paint coat composed of at least two layers—an inner layer and an outer layer—is formed on the outside surface of the cover. The inner paint layer is formed of a coating composition containing an acrylic resin and a urethane resin as the base resins. Because an ionomer resin, urethane resin or the like is included as the base resin in the golf ball cover, by using an acrylic resin and a urethane resin in the inner paint layer that is in contact with both the cover and the outer paint layer, affinity with the cover and adhesion with the outer paint layer can be enhanced.

The weight ratio of acrylic resin to urethane resin (acrylic resin:urethane resin) is preferably from 30:70 to 80:20, more preferably from 50:50 to 80:20, and even more preferably from 60:40 to 70:30. In particular, by increasing the ratio of acrylic resin, adhesion with the ionomer resin included in the cover material can be increased; it is thus preferable for the proportion of acrylic resin to be 50 wt % or more. On the other hand, by increasing the proportion of urethane resin, owing to the flexibility of urethane resin, the abrasion resistance of the overall paint coat can be increased.

The acrylic resins that may be used are exemplified by resins obtained by polymerizing one or more acrylic monomer selected from the group consisting of acrylic acid, methacrylic acid and esters thereof, and resins obtained by copolymerizing one or more acrylic monomer with one or more monomer other than an acrylic monomer. Of acrylic monomers, specific examples of acrylic acid esters and methacrylic acid esters include alkyl (meth)acrylates such as methyl (meth)acrylate, ethyl (meth)acrylate and butyl (meth)acrylate, and also benzyl (meth)acrylate, 2-hydroxyethyl (meth)acrylate, 2-hydroxypropyl (meth)acrylate, 2-hydroxybutyl (meth)acrylate and glycidyl (meth)acrylate. A specific example of a monomer other than an acrylic monomer is styrene. Of these, the use of acrylic acid esters as the acrylic resin is preferable for enhancing the adhesion.

Urethane resins that may used are exemplified by urethane bond-containing resins obtained by reacting a polyol component with a polyisocyanate component. Examples of the polyol component include polyesters, polyethers and polycarbonates. Examples of the polyisocyanate component include tolylene diisocyanate (TDI), diphenylmethane diisocyanate (MDI), dicyclohexylmethane diisocyanate (hydrogenated MDI), 1,5-naphthalene diisocyanate (NDI), xylylene diisocyanate (XDI), isophorone diisocyanate (IPDI) and hexamethylene diisocyanate (HDI). Of these, from the standpoint of imparting flexibility, the use of a polyether-type urethane resin is preferred.

The coating composition for the inner paint layer is preferably a water-based coating composition. As used herein, “water-based coating composition” refers to a composition containing a base resin dissolved or dispersed in water. Water-based resin compositions are classified according to the stabilized state of the resin within water as water-soluble coating compositions and water-dispersible coating compositions. In a preferred embodiment of the invention, the composition is preferably in the form of a water-dispersible coating composition. Water-dispersible coating compositions are classified according to the particle size of the resin as colloidal dispersions (having a particle size of from about 0.005 μm to about 0.05 μm) and emulsions (having a particle size of from about 0.05 μm to about 0.5 μm). In the embodiments of the invention, the water-dispersible coating composition may be either a colloidal dispersion or an emulsion. Examples include emulsion-type coatings of acrylic resins and colloidal dispersion type coatings of urethane resins; these may also be mixed to form a water-dispersible coating composition.

The coating composition of the inner paint layer may include, aside from the above base resin, a crosslinking agent. In cases where the acrylic resin or urethane resin has crosslinking reactive groups, depending on the crosslinking reactive groups, the composition may include a crosslinking agent. Examples of the crosslinking agent include, but are not limited to, methylol compounds, polyepoxy compounds, amino resins, polyaziridine compounds, polyoxazoline compounds, polyisocyanate compounds, sulfur compounds, hydrazine compounds, silane coupling agents and chelating agents. The crosslinking agent is preferably one that dissolves in the solvent of the water-based coating composition. Water is chiefly used as the solvent in the water-based coating composition. The crosslinking agent content is preferably set to from 0.1 to 5 parts by weight per 100 parts by weight of the base resin.

The inner paint layer has a thickness (film thickness) which, to enhance the impact resistance, is set to preferably at least 5 μm, more preferably at least 6 μm, and even more preferably at least 7 μm. In order to maintain flight-enhancing properties, the upper limit to this thickness (film thickness) is preferably 15 μm or less, and more preferably 13 μm or less.

The method of forming the inner paint layer on the surface of the cover is not particularly limited, although use can be made of known methods for applying a golf ball coating onto the cover surface. For example, a method such as spray painting or electrostatic painting may be used.

The outer paint layer is formed on the outside surface of the inner paint layer. The material of this outer paint layer is a two-part curable urethane coating composition containing a polyol component and a polyisocyanate component. Examples of coating compositions that may be used to form this outer paint layer include two-part curable urethane coating compositions containing primarily a polyol component composed mainly of hydroxyl group-containing polyester polyol having alicyclic structures on the molecule and a non-yellowing polyisocyanate, and two-part curable urethane coating compositions containing primarily a polyol component composed mainly of acrylic polyol and an elasticity-modified polyisocyanate.

### [Two-Part Curable Urethane Coating Containing Polyol Composed Mainly of Hydroxyl Group-Containing Polyester Polyol Having Alicyclic Structures on Molecule, and Non-Yellowing Polyisocyanate]

The hydroxyl group-containing polyester polyol having alicyclic structures on the molecule is obtained by reacting a polyhydric alcohol component having an alicyclic structure on the molecule with a polybasic acid component.

Preferred examples of the polyhydric alcohol component having an alicyclic structure on the molecule include diols such as 1,3-cyclohexanedimethanol and 1,4-cyclohexanedimethanol, and mixtures of these. Preferred examples of the polybasic acid component having an alicyclic structure on the molecule include dicarboxylic acids such as tetrahydrophthalic acid, hexahydrophthalic acid, 1,3-cyclohexanedicarboxylic acid and 1,4-cyclohexanedicarboxylic acid, acid anhydrides of these, acid halides of these, and mixtures of these.

The above polyhydric alcohol component or polybasic acid component having an alicyclic structure on the molecule may account for part or all of the ingredients making up the hydroxyl group-containing polyester. The polyhydric alcohol component having an alicyclic structure on the molecule accounts for preferably at least 3 wt %, and more preferably from 5 to 40 wt %, of the overall polyhydric alcohol component. The polybasic acid component having an alicyclic structure on the molecules accounts for preferably at least 5 wt %, and more preferably from 10 to 55 wt %, of the overall polybasic acid component. When the contents of the alicyclic structure-containing polyhydric alcohol component and polybasic acid component fall outside of the above ranges, the durability of the painted golf ball to sand abrasion and grass stains is inadequate.

Examples of polyhydric alcohol components without an alicyclic structure on the molecule that may be used together with the above polyhydric alcohol component having an alicyclic structure on the molecule include ethylene glycol, diethylene glycol, triethylene glycol, propylene glycol, dipropylene glycol, butylene glycol, 1,6-hexanediol, neopentyl glycol, 3,3-dimethylolheptane, polyethylene glycol, polypropylene glycol, glycerol, trimethylolethane, trimethylolpropane, pentaerythritol, and mixtures thereof.

Examples of polybasic acid components without an alicyclic structure on the molecule that may be used together with the above polybasic acid component having an alicyclic structure on the molecule include dicarboxylic acids such as adipic acid, sebacic acid, dimer acid, phthalic acid, isophthalic acid, terephthalic acid, maleic acid, fumaric acid and itaconic acid, acid anhydrides of these, acid halides of these, and mixtures thereof.

As mentioned above, the hydroxyl group-containing polyester is a compound that can be obtained by subjecting the above polyhydric alcohol component and polybasic acid component to an esterification reaction. The hydroxyl group-containing polyester thus obtained is one having a weight-average molecular weight, as determined by gel permeation chromatography, of preferably from 3,000 to 35,000 and a hydroxyl value of preferably from 50 to 300, especially from 150 to 250. When the weight-average molecular weight and hydroxyl value of the hydroxyl group-containing polyester fall outside of the above ranges, the durability of the painted golf ball to sand abrasion and grass stains is inadequate.

Preferred examples of the non-yellowing polyisocyanate include adducts, biurets and isocyanurates of, for example, hexamethylene diisocyanate, isophorone diisocyanate and hydrogenated xylylene diisocyanate, and also mixtures of these.

The above hydroxyl group-containing polyester and non-yellowing polyisocyanate are preferably used in such a way that the molar ratio of isocyanate groups on the non-yellowing polyisocyanate to hydroxyl groups on the hydroxyl group-containing polyester is within the range of 0.8 to 1.3.

### [Two-Part Curable Urethane Coating Containing Primarily a Polyol Component Composed Mainly of Acrylic Polyol and Elasticity-Modified Polyisocyanate]

As used herein, “acrylic polyol” refers to a compound having an acrylic polymer backbone and polyester and/or polyether side chains.

The acrylic polymer is not particularly limited as to the structure thereof and may have any structure so long as the basic skeleton includes acrylic recurring units. The acrylic monomer making up the backbone may be of one type only or may be of two or more types. Alternatively, the acrylic polymer may be one that has been copolymerized from an acrylic monomer and another monomer that is copolymerizable therewith.

The specific structure of the acrylic polyol is exemplified by (i) structures obtained by adding a lactone or alkylene oxide side chain-forming component to an acrylic polymer backbone; (ii) structures obtained by adding a novel monomer and an initiator in the presence of an acrylic polymer, and grafting side chains onto the acrylic polymer backbone by monomer polymerization; (iii) structures obtained by homopolymerizing an acrylic monomer to which polyester has been added (abbreviated below as “polyester-containing acrylic monomer”) and/or an acrylic monomer to which polyether has been added (abbreviated below as “polyether-containing acrylic monomer”); and (iv) structures obtained by copolymerizing a polyester-containing acrylic monomer and/or a polyether-containing acrylic monomer with another acrylic monomer.

The elasticity-modified polyisocyanate is obtained by using as the monomer a diisocyanate such as the above-mentioned tolylene diisocyanate (TDI), xylene diisocyanate (XDI), diphenylmethane diisocyanate (MDI), hexamethylene diisocyanate (HDI) or isophorone diisocyanate (IPDI) and subjecting this to a urethane-forming reaction with an active hydrogen-containing compound having elasticity to give an NCO-terminated prepolymer. The conditions for the urethane-forming reaction are not particularly limited and may be in line with conventional conditions.

Examples of the active hydrogen-containing compound having elasticity that is used for modifying the elasticity of the above polyisocyanate include polyester polyols, polycarbonate polyols, polyether polyols, polyolefin polyols, animal and plant polyols, and copolyols of these. It is especially preferable to include a modified polyisocyanate that has been modified with at least one type of polyol selected from the group consisting of polyester polyols, polyether polyols, polycarbonate polyols, polyolefin polyols, animal and plant polyols and copolymers of these. To make the resulting paint film more elastic and further improve the impact resistance, it is preferable for these polyols to have a glass transition temperature Tg of 0° C. or less. These polyols may be used singly or two or more may be used in admixture.

The coating composition includes an inorganic or organic filler. To maintain the transparency of the paint coat and impart a reinforcing effect and a sag-preventing effect, various inorganic or organic substances may be employed as this inorganic or organic filler. Specific examples include polyurethane particles, silicon dioxide (silica), carbon and titanium oxide. The polyurethane particles are exemplified by thermoplastic polyurethane particles and three-dimensionally crosslinked polyurethane particles, such as the polyurethane particles described in JP-A 2017-78149.

The inorganic or organic filler has an average particle size based on the BET method of preferably at least 0.1 μm, and more preferably at least 0.2 μm. The upper limit is preferably not more than 10 μm. By thus adding an inorganic or organic filler having an average particle size within a given range to the above coating composition, sagging of the paint can be suppressed, the film thickness edge ratio between the film thicknesses at center and edge portions of the dimples can be improved, and the scratch resistance and peel resistance of the paint coat, as well as the protective effect on ball markings, can be improved.

The filler content with respect to the solids content of the base resin in the coating composition is less than 5 wt %, preferably less than 3 wt %, and more preferably less than 2 wt %. A content larger than the above upper limit may have an adverse influence on the clarity of the paint film. This content has a lower limit of preferably 0.1 wt % or more, more preferably 0.3 wt % or more, and even more preferably 0.5 wt % or more. When this numerical value is too small, the paint coat thickness uniformity-enhancing effect that is a desired effect of the invention becomes small.

As noted above, the coating composition uses an acrylic polyol or a polyester polyol as the base resin and uses a polyisocyanate as the curing agent. Various organic solvents may be admixed depending on the painting conditions. Examples of organic solvents that may be used include aromatic solvents such as toluene, xylene and ethylbenzene; ester solvents such as ethyl acetate, butyl acetate, propylene glycol methyl ether acetate and propylene glycol methyl ether propionate; ketone solvents such as acetone, methyl ethyl ketone, methyl isobutyl ketone and cyclohexanone; ether solvents such as diethylene glycol dimethyl ether, diethylene glycol diethyl ether and dipropylene glycol dimethyl ether; alicyclic hydrocarbon solvents such as cyclohexane, methylcyclohexane and ethylcyclohexane; and petroleum hydrocarbon-based solvents such as mineral spirits.

Known paint compounding ingredients may be optionally added to the coating composition. Specifically, suitable amounts of, for example, thickeners, ultraviolet absorbers, fluorescent whiteners, slip agents and pigments may be added.

To suppress sagging of the paint and improve the film thickness edge ratio between the film thicknesses at the center and edge portions of the dimples, following mixture of the two parts—the polyol component and the isocyanate component, the coating composition preferably has a viscosity, as tested by the method of JIS-K 5600-2-2 (1999), of at least 0.025 Pa·s, and more preferably at least 0.030 Pa·s.

When the above coating composition is used, a paint layer can be formed on the ball surface via the steps of preparing the coating composition at the time of application, applying the coating composition to the surface using a conventional painting operation, and drying. In this case, preferred, non-limiting examples of the painting method used include spray painting, electrostatic painting and dipping.

In the above drying step, which is similar to that used with known two-part curable urethane paints, the drying temperature may be set to about 40° C. or more, especially between 40° C. and 60° C., and the drying time may be set to from 20 to 90 minutes, especially from 40 to 50 minutes.

Methods commonly used for surface painting golf balls may be employed as the method for applying the above coating composition. Examples of such methods include brush painting, spray painting and electrostatic painting. The thickness of the paint film is preferably from 10 to 30 μm, and more preferably from 17 to 23 μm.

An essential feature of the inventive golf ball is that, defining the ratio in a dimple cross-section between the thickness of a paint layer (film thickness) formed at a center portion (bottom) of the dimple and the thickness of the paint layer formed at edge portions of the dimple as the edge ratio:

(film thickness at dimple edge)/(film thickness at dimple center)×100,

and letting E1 be the edge ratio of the inner paint layer, E2 be the edge ratio of the outer paint layer and ET be the edge ratio of the overall paint coat, the golf ball satisfies the two conditions −10≤E2-E1≤10 and ET-E2≥0. The condition relating to the difference E2-E1 signifies that high edge ratios are obtained for both the inner paint layer and the outer paint layer, and that the dispersion in the edge ratios is small. ET-E2 is the value obtained by subtracting the edge ratio for the outer paint layer from the edge ratio for the overall paint coat, and the condition relating to this signifies that the edge ratio of the inner paint layer is a relatively high value. By satisfying these two conditions, the film thickness edge ratios between the center and edge portions of the dimples can be improved, and the scratch resistance and peel resistance of the paint coat and also the protective effect on ball markings can be improved.

The edge ratio, which is the ratio of the film thickness at edge portions of a dimple to the film thickness at the center portion (bottom) of the dimple, when closer to 100%, indicates that the film thickness in the dimple is more uniform, and thus serves as an indicator for evaluating the uniformity of the paint film. The edge ratios of the respective paint layers (E1, E2) are preferably at least 50%, and more preferably at least 70%. Generally, when attempting to form a thick paint film on the concave surface of a dimple, the film thickness at the edge portions where the concavity is shallow becomes thinner and the film thickness at the center portion where the concavity is deep becomes thicker. In cases where a paint film having a high elastic recovery is formed, this tendency becomes pronounced, and so forming a film thickness of 10 μm or more at the edge portions of a dimple is difficult. In the embodiments of the invention, by using a solvent having a boiling point of 80° C. or less, the edge ratio can be set to 50% or more even when an outer paint film having an elastic recovery of at least 50% is formed to a film thickness of 10 μm or more at the edge portions of the dimple.

The golf ball has a compressive hardness (deformation) when compressed under a final load of 1,275 N (130 kgf) from an initial load state of 98 N (10 kgf) which is at least 2.7 mm, preferably at least 2.8 mm, and more preferably at least 3.0 mm. The upper limit is preferably not more than 3.6 mm, more preferably not more than 3.5 mm, and even more preferably not more than 3.4 mm. When the compressive hardness falls outside of the above range, the feel of the ball at impact may be too soft or too hard, as a result of which the hardness is desirable only to specific users, making the ball unsuitable particularly as a practice golf ball. Moreover, when the compressive hardness is too hard, this leads to early cracking of the ball, resulting in a loss of properties as a practice golf ball.

### EXAMPLES

The following Examples and Comparative Examples are provided to illustrate the invention, and are not intended to limit the scope thereof.

### Examples 1 to 6, Comparative Examples 1 to 5

Golf balls having dimples thereon and composed of a 39.3 mm diameter core encased with a cover formed by injection-molding the ionomer resin shown in Table 1 to a thickness of 1.7 mm were prepared.

TABLE 1

| Resin material (pbw) | A | B | C |
|---|---|---|---|
| S 8940 | 50 | 50 | 70 |
| S 9910 | 10 | 20 | 15 |
| S 9320 | 40 | 30 | 15 |
| Material hardness (Shore D) | 56 | 58 | 62 |

The above resin materials S 8940, S 9910 and S 9320 are all Surlyn™ series ionomer resins available from The Dow Chemical Company.

Two-layer painting was carried out as described below on the above golf balls.

### [Formation of Two-Layer Paint Coat]

In Examples 1 to 3 and Comparative Examples 1 to 3, primer treatment was carried out using a water-based primer composition composed of the base resin shown in Table 2, thereby forming an inner paint layer. This water-based primer composition was applied with an automatic spray gun to an inner paint layer thickness of from 8 to 9 μm. The water-based primer composition was a material obtained by mixing together Acryl Primer (base resin) made by Cashew Co., Ltd., Crosslinker CX-100 (curing agent) and water in a weight ratio of 100:1.5:3. This composition was then dried at 55° C. for 30 minutes and furnished for testing.

Next, the inner paint layer had a specific logo (marking) applied thereon, following which the coating composition composed of the base resins and curing agents shown in Table 2 was applied with an automatic spray gun to an outer paint layer thickness of 20 μm. This composition was then dried at 55° C. for 1 hour and furnished for testing.

In Examples 4 to 6 and Comparative Examples 4 and 5, primer treatment is similarly carried out using a water-based primer composition composed of the base resins shown in Table 2, thereby forming an inner paint layer. A specific logo (marking) is applied thereon, after which an outer paint layer is formed using the coating composition composed of the base resins and curing agents shown in Table 2.

TABLE 2

| Coating formulation (pbw) | | a | b | c | d | e | f | g |
|---|---|---|---|---|---|---|---|---|
| Base resin | Acrylic resin | 70 | — | — | — | — | — | — |
| | Urethane resin | 30 | — | — | — | — | — | — |
| | Polyol | — | 30 | 30 | 30 | 30 | 30 | 30 |
| | Ethyl acetate | — | 70 | 70 | 70 | 70 | 70 | 70 |
| | Urethane resin particles | — | | | 1.0 | | | |
| | Silica particles | — | | 1.0 | | 10 | 0.5 | 3.0 |
| Curing agent | HDI | — | 21 | 21 | 21 | 21 | 21 | 21 |
| | Butyl acetate | — | 29 | 29 | 29 | 29 | 29 | 29 |

| | | | | | | | |
|---|---|---|---|---|---|---|---|
| Viscosity (Pa · s) | — | 0.028 | 0.028 | 0.032 | 0.040 | 0.028 | 0.033 |

*Polyol: Acrylic polyol + polyester polyol
*HDI: Hexamethylene diisocyanate

### [Measurement of Coating Composition Viscosity]

The coating composition viscosity is measured immediately after two-part mixture (mixture of the polyol and the polyisocyanate). The viscosity is measured by the flow cup method, determination of the viscosity being carried out according to JIS-K 5600-2-2 (1999). The measurement apparatus used is the NK-2 viscosity cup from Anest Iwata Corporation, and the test is carried out within a chamber set to a temperature of 22.8° C.

The scratch resistance, mark peelability, surface glossiness and durability to cracking of the golf balls obtained in each example are evaluated by the test methods described below. The results are presented in Table 3.

### [Wet Abrasion Test]

A pot mill with an outside diameter of 210 mm is charged with about 4 kg of approximately 5-mm sand and water, 15 balls are placed therein, and the contents of the mill are stirred for 120 minutes at a rotational speed of 50 to 60 rpm. The golf balls are then removed from the pot mill and irradiated with a UV lamp (here and below, IDHR-100S-UV-365 from Leimac, Ltd.), and the scratch resistance, mark peelability and surface glossiness described below are evaluated.

### (I) Scratch Resistance:

To determine the scratch resistance, the surface of the golf ball is magnified with a loupe and the degree of fine scratches on the paint film is examined. This is rated according to the following criteria. The scratch resistance rating shown in Table 3 for each example is the average for five golf balls.
5: No scratches
4: Small number of scratches
3: Many scratches
2: Scratches with burs observed
1: Scratches with gouging observed

### (II) Mark Peelability:

The mark peelability is determined by irradiating each golf ball with a UV lamp and examining the peeled state of markings due to abrasion at the ball surface. The results is assigned scores based on the criteria shown below. The score shown for each example in Table 3 is the average score for five golf balls.
7: No peeling
6: Very slight peeling
5: Modest degree of peeling
4: Much peeling, but markings are legible
3: Much peeling, but markings are legible with some difficulty
2: Much peeling and markings are illegible
1: All markings have peeled off

### (III) Surface Gloss:

The surface gloss is determined by magnifying the golf ball surface with a loupe and examining the dimples and lands for the presence or absence of surface gloss. The results are assigned scores based on the criteria shown below. The score shown for each example in Table 3 is the average score for five golf balls.
7: Both lands and dimple interiors are glossy
6: Lands are slightly dull but dimple interiors are glossy
5: Lands are dull in many places but dimple interiors are glossy
4: Lands substantially lack gloss and dimple interiors are slightly dull
3: Lands lack gloss and dimple interiors are dull in many places
2: Lands lack gloss and dimple areas are largely dull
1: Lands and dimple interiors both lack gloss

### [Edge Ratio (%)]

In the cross-section of a dimple D shown in the Figure, the thicknesses t of the respective paint layers (inner paint layer and outer paint layer) P at the center M of the dimple and at the edges E, E are determined. First, a region that includes the largest dimple is cut to a diameter of about 10 mm from a place on the ball surface other than the vicinity of the equator and the vicinity of the poles, and is then further cut so as to expose the cross-section of the largest dimple portion. Next, the dimple cross-section is examined under a microscope and, as shown in the Figure, the positions in the cross-section where the height on the surface reaches a maximum are treated as the dimple edges E, E. The position below the normal that extends out from the position halfway along the length of the straight line joining the edges E, E is treated as the center M of the dimple.

The edge ratio (%) is computed from the following formula:

(average of film thicknesses at dimple edges E,E)/(film thickness at dimple center M)×100

The film thickness becomes more uniform as the edge ratio approaches 100%. Table 3 shows the values for E2-E1 and ET-E2, where E1 is the edge ratio of the inner paint layer, E2 is the edge ratio of the outer paint layer, and ET is the edge ratio for the overall paint coat.

### [Durability to Cracking]

The durability of the ball is evaluated using the ADC Ball COR Durability Tester manufactured by Automated Design Corporation (U.S.). This tester fires a golf ball pneumatically, causing it to consecutively strike two metal plates arranged in parallel. The incident velocity against the metal plates is set to 43 m/s. The number of shots required for the golf ball to crack is measured, and the average value of the measurements taken for ten golf balls is calculated.

TABLE 3

| | | Example | | | | | | Comparative Example | | | | |
|---|---|---|---|---|---|---|---|---|---|---|---|---|
| | | 1 | 2 | 3 | 4 | 5 | 6 | 1 | 2 | 3 | 4 | 5 |
| Core | Diameter (mm) | 39.3 | 39.3 | 39.3 | 39.3 | 39.3 | 39.3 | 39.3 | 39.3 | 39.3 | 39.3 | 39.3 |
| | Compressive hardness (mm) | 3.5 | 3.5 | 3.5 | 3.1 | 3.5 | 3.5 | 3.5 | 3.5 | 2.5 | 4 | 2.5 |
| Cover | Material | B | B | A | B | B | B | B | C | C | B | B |
| Ball | Compressive hardness (mm) | 3.2 | 3.2 | 3.2 | 2.8 | 3.2 | 3.2 | 3.2 | 3.2 | 2.3 | 3.7 | 2.3 |
| Inner | Material | a | a | a | a | a | a | a | a | a | a | a |
| paint layer | Edge ratio E1 (%) | 75 | 75 | 75 | 75 | 75 | 75 | 75 | 75 | 75 | 75 | 75 |
| Outer | Material | c | d | c | c | f | g | b | c | e | c | e |
| paint layer | Edge ratio E2 (%) | 82 | 74 | 80 | 82 | 79 | 85 | 66 | 77 | 65 | 78 | 92 |
| Two | Overall edge ratio ET (%) | 84 | 74 | 80 | 84 | 84 | 90 | 65 | 80 | 79 | 81 | 92 |
| paint layers | | | | | | | | | | | | |
| Edge ratio | E2 − E1 (%) | 7 | −1 | 5 | 7 | 4 | 10 | −9 | 2 | −10 | 3 | 17 |
| relationships | ET − E2 (%) | 2 | 0 | 0 | 2 | 5 | 5 | −1 | 3 | 14 | 3 | 0 |
| Appearance | Scratch resistance (score) | 4 | 4 | 3 | 4 | 4 | 4 | 4 | 3 | 2 | 2 | 2 |
| properties | Marking peelability (score) | 7 | 7 | 6 | 7 | 6 | 6 | 4 | 3 | 6 | 6 | 4 |
| | Surface glossiness (score) | 7 | 7 | 6 | 6 | 6 | 6 | 3 | 6 | 7 | 6 | 3 |
| Ball | Cracking (number of shots) | 230 | 230 | 210 | 220 | 230 | 225 | 230 | 190 | 150 | 200 | 220 |
| performance | | | | | | | | | | | | |

As shown in Table 3, the golf balls in Examples 1 to 6 have at the ball surface a good scratch resistance, substantially no peeling of markings and excellent glossiness. In addition, the durability to cracking is excellent. By contrast, as is apparent from Table 3, the golf balls in Comparative Examples 1 to 5 are inferior in the following respects to the balls obtained in the Examples of the invention.

In Comparative Example 1, the outer paint layer does not include an organic or inorganic filler. As a result, in the edge ratio relationships, ET-E2<0, much peeling of the markings occurred, and the surface glossiness was poor.

In Comparative Example 2, the material hardness of the cover was 60 or more and thus high, the scratch resistance was poor, and much peeling of the markings occurred.

In Comparative Example 3, the material hardness of the cover was 60 or more, making the ball hard, the compressive hardness of the finished ball was smaller than 2.7 mm, and the scratch resistance and durability to cracking were poor.

In Comparative Example 4, the compressive hardness of the finished ball is larger than 3.3 mm, making the ball soft, and the scratch resistance is poor.

In Comparative Example 5, the outer paint layer had a high content of organic or inorganic filler, and so the scratch resistance is poor, the surface glossiness is poor, and much peeling of the markings occurred.

Japanese Patent Application No. 2023-215479 is incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A golf ball comprising a core and a cover of at least one layer which encases the core and has an outer surface on which numerous dimples are formed,
wherein the cover has a material hardness on the Shore D hardness scale of less than 60;
the outer surface of the cover has a paint coat thereon which is composed of at least two layers—an inner layer and an outer layer, the inner paint layer being formed of a coating composition that includes as base resins an acrylic resin and a urethane resin and the outer paint layer being formed of a two-part curable urethane coating composition that includes a polyol component and a polyisocyanate component and contains less than 5 wt % of an inorganic or organic filler based on the solids content of the base resins;
in a dimple cross-section, defining the ratio between the thickness of a paint layer (film thickness) formed at a center portion (bottom) of the dimple and the thickness of the paint layer formed at edge portions of the dimple as the edge ratio:
$$( film thickness at dimple edge ) / ( film thickness at dimple center ) \times 100 ,$$
and letting E1 be the edge ratio of the inner paint layer, E2 be the edge ratio of the outer paint layer and ET be the edge ratio of the overall paint coat, the golf ball satisfies the conditions
$$- 10 \leq E 2 - E 1 \leq 10 and$$
$$ET - E 2 \geq 0 ;$$
and
the golf ball, when compressed under a final load of 1,275 N (130 kgf) from an initial load state of 98 N (10 kgf), has a compressive deformation of from 2.7 to 3.3 mm.

2. The golf ball of claim 1, wherein the coating composition for the inner paint layer has an acrylic resin content that is at least 50 wt % of the overall base resin.

3. The golf ball of claim 1, wherein the inorganic or organic filler in the coating composition for the outer paint layer has an average particle size based on the BET method of from 0.1 to 1.0 μm.

4. The golf ball of claim 1, wherein the two-part curable urethane coating composition for the outer paint layer includes a polyol component which is composed primarily of a hydroxyl group-containing polyester polyol having an alicyclic structure on the molecule and a non-yellowing polyisocyanate.

5. The golf ball of claim 1, wherein the two-part curable urethane coating composition for the outer paint layer includes a polyol component which is composed primarily of an acrylic polyol and an isocyanate component which is composed primarily of an elastic modified polyisocyanate.

6. The golf ball of claim 1, wherein the two-part curable urethane coating composition has a viscosity following mixture of the two parts which is at least 0.025 Pa·s, as measured by the test method of JIS-K 5600-2-2 (1999).

7. The golf ball of claim 1, wherein the inner paint layer has a thickness of from 5 to 15 μm.

8. The golf ball of claim 1, wherein the outer paint layer has a thickness of from 17 to 23 μm.

9. The golf ball of claim 1, wherein the core has a diameter of 40 mm or less and, when compressed under a final load of 1,275 N (130 kgf) from an initial load state of 98 N (10 kgf), has a compressive deformation of from 3.0 to 4.0 mm.

10. The golf ball of claim 1, wherein at least one layer of the cover is formed of a resin composition containing component (a) below or component (b) below or both:
(a) an ionic ethylene-methacrylic acid-unsaturated carboxylic acid copolymer having an unsaturated carboxylic acid content of 5 wt % or more,
(b) an ionic ethylene-methacrylic acid-unsaturated carboxylic acid ester copolymer having an unsaturated carboxylic acid content of 5 wt % or more.
